(19) United States
(12) Patent Application Publication
(10) Pub. No.: US 2009/0177529 A1
(43) Pub. Date: Jul. 9, 2009

(54) Internet eco system for transacting information and transactional data for compensation

(76) Inventor: Altaf Hadi, Murphy, TX (US)

Correspondence Address: Altaf Hadi, 123 Glen Ridge Dr., Murphy, TX, 75094, US

(21) Appl. No.: 12/317,759

(22) Filed: Dec. 29, 2008

Related U.S. Application Data
(60) Provisional application No. 61/009,688, filed on Dec. 31, 2007.

(51) Int. Cl. G06Q 30/00; G06F 17/30; G06F 17/40; G06Q 10/00; G06Q 20/00; G06Q 50/00

(52) U.S. Cl. 705/10; 707/104.1; 707/3; 705/14; 707/5; 707/E17.017; 707/E17.018; 707/E17.028; 707/E17.019

(57) ABSTRACT

In one embodiment, an Internet eco system includes a data posting platform securely accessible over the Internet to post personal, confidential and business data for conducting informational and transactional transactions for compensation. In another embodiment, the Internet eco system enables data providers to earn monetary compensation, system credits compensation or barter based compensation. In another embodiment, the Internet eco system enables data posting based upon freeform, system forms, keywords, mathematical logic, constraints, policies, facts, rules, workflow, or context logic; such data can be searched and retrieved based upon keywords, mathematical logic, constraints, policies, facts, rules, workflow, or context based search criteria. In yet another embodiment, the Internet eco system provides methods for authentication, authorization, accounting, data indexing, data classification, heuristics, activity metering, fraud detection and prevention, user identification, verification and dispute resolution, providing feedback, payments and systems credit settlement, providing virtual agent capabilities and third party interfacing capabilities and for providing interfaces to search logic. In yet another embodiment of the Internet eco system provides methods for data providers and data consumers to engage in and to consummate social networking based transactions.

### TECHNICAL FIELD OF THE INVENTION

This invention relates generally to transactions on the Internet and more particularly to posting personal, confidential and business data for conducting informational data based transactions and transactional based transactions in an Internet eco system for systems credit based compensation, monetary compensation, barter compensation, or a combination of monetary and barter compensation.

### BACKGROUND OF THE INVENTION

Today, providers of data, in particular, providers of personal data do not get paid for offering their data for use and consumption by other entities. Data about individuals and families is collected in a myriad number of ways to generate monetary profit and other benefits by corporations and government entities. However, the providers of the data are not compensated monetarily for their information. For example, job boards such as Monster, Dice, Career Builder and Yahoo Hot Jobs etc. reap huge monetary benefits by soliciting individuals to post their information on their sites but job seekers do not benefit monetarily by posting their personal and professional information on such job boards. Similarly, personal networking sites such as YouTube, MySpace and FaceBook etc. generate significant advertisement revenues and are sold for hundreds of millions of dollars by collecting data and information from individuals; the providers of such data and information are left out from the monetary benefits. On the flip side, organizations spend large sums of money to reach target consumers; much of this revenue is inefficiently spent. Often times government entities cannot timely and effectively communicate with their constituents due to huge costs. The present innovation provides an Internet based eco system for individuals, non-profit and for profit corporations and government entities to benefit monetarily or in other ways by sharing data and information about themselves; their business activities with each other effectively; the present innovation also enables data providers to post transactional data to conduct transactions.

Then there is the increasing global issue of qualified resource shortages. To remain competitive in today's global economy, corporations and government entities have a continual need to implement new technology based solutions while at the same time leverage new technology to innovate and bring new products to market. These corporation and government entities dilemma is compounded by the lack of availability of skilled resources where they may be operating from. Today, this is true in North America and Europe. India and China too are facing shortages of educated and skilled labor. The present innovation, amongst other criteria, provides policies, rules, constraints, facts, workflow and context based data posting techniques by means of which corporations can post their labor, projects and product development requirements and obtain precision results. Using the same criteria of policies, rules, constraints, facts, workflow and context, qualified individuals and business entities can search the labor, projects and product development requirements of corporations and government agencies to perform the required work. This technique of work posting and work search also provides synergies for the elimination of duplicate work performed; for example, corporation A may want to undertake a technology based infrastructure implementation project while a corporation B in a different part of the world may already have implemented a similar project for their organization. If corporation A and corporation B are not direct competitors they could work together to implement the solution in corporation A. Corporation B may benefit monetarily while Corporation A benefits in terms of lower cost, rapid deployment and increased business agility. Even competitors may choose to cooperate for their mutual benefits. The present innovation also enables a new breed of global service provider organizations to emerge in finding synergistic work opportunities.

The Internet eco system of the present invention provides a means for Consumers, Corporation and Government entities to conduct informational data based transactions and transactional data based transactions to earn compensation and or barter benefits by sharing their personal, confidential and business data.

### SUMMARY OF THE INVENTION

An Internet based eco system for facilitating data providers' data and information view(s) for the access, use and benefit of data consumers. The data consumers shall pay a pay-per-access micro fee or a flat rate fee or a periodic subscription fee or by means of system credits for the access and use of data providers informational data. Data providers can also post transactional data; transactional data can be related to buy, sell, lease, rent and other forms of transactions for transacting products and services. In transactions involving both information data and transactional data, data providers can choose to receive compensation in the form of monetary compensation and or barter based compensation.

Data providers can be individuals, for profit and not for profit organizations and government entities while data consumers can be individuals, for profit and not for profit organizations and government entities.

### BRIEF DESCRIPTION OF THE DRAWINGS

To provide a more complete understanding of the present invention and the features and advantages thereof, reference is made to the following description, taken in conjunction with the accompanying drawing, in which:

FIG. 1 illustrates an example Internet eco system for transacting informational data and transactional data for compensation.

FIG. 2 illustrates an example application engine of an Internet eco system for transacting informational data and transactional data for compensation.

FIG. 3 illustrates an example search engine of an Internet eco system for transacting informational data and transactional data for compensation.

### DESCRIPTION OF EXAMPLE EMBODIMENTS

As used herein, the functional terminology of [i] data and information can be used interchangeably to convey the same meaning or used distinctly to convey different meaning, [ii] informational data refers to data that primarily conveys information; for example a job applicant's resume [iii] transactional data refers to data that is primarily intended for the sale, purchase, barter, lease or rent of tangible and intangible products and or services; for example a car sale or the sale of a technology solution [iv] micro payment and fractional payment can be used interchangeably to convey the same meaning, [v] no payment, payment free and zero payment can be used interchangeably to convey the same meaning [vi] data consumers and data users can be used interchangeably to convey the same meaning [vii] personal, confidential and business data can be of informational type and can also be of transactional type [viii] index and score can be used interchangeably. [ix] System users, Internet eco system users and Informational eco system users can be used interchangeably. The term “data providers” and “data consumers” encompasses authorized users of the Internet eco system of the present innovation wherein data providers post data and data consumers access use and engage in transactions based on data providers' data; data providers can be of the type of consumers, for profit corporations, not for profit corporation and governed entities; data consumers can be of the type of retail consumers, for profit corporations, not for profit corporation and governed entities; [x] The terms truth meter, truth index and identification index can be used interchangeably.

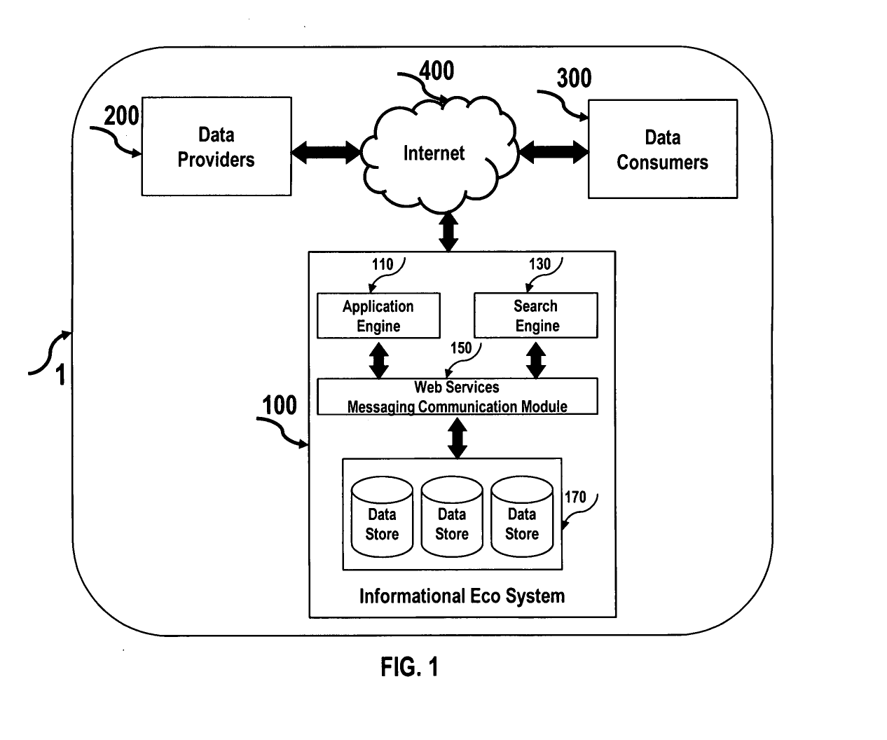

FIG. 1 illustrates an example Internet eco system 1 for transacting informational data and transactional data for compensation. The Internet eco system 1, generally includes, an informational eco system 100, data providers 200, data consumers 300 and the Internet 400. Data providers 200 post personal, confidential and business data to the informational eco system 100 by accessing the informational eco system 100 over the Internet 400. Data consumers 300, by means of the Internet 400, access use and conduct transactions based on the personal, confidential and business data posted to the informational eco system 100 by the data providers 200.

The informational eco system 100 is the heart of the Internet eco system 1; it includes several logic components of the type software and or hardware of which the application engine 110, search engine 130, the web services message communication module 150 and the data store 170 are unique to this invention.

The Internet eco system 1 provides a mechanism for the data providers 200 and data consumers 300 to access the informational eco system 100 thru the Internet 400. The informational eco system 100 in turn enables temporary users to create profiles for transactions or authorized and temporary users to login to the said eco system 100 for conducting transaction. Temporary users are those users who prefer not to create a profile on the informational eco system 100 for posting data but only perform payment based or payment free transactions.

Data providers 200 can also be data consumers 300 and data consumers 300 can also be data providers 200.

Upon creating a profile and subsequently getting verified and or identified by the informational eco system 100, data providers 200 and data consumers 300 are considered as authorized users of the Internet eco system 1. The informational eco system 100 offers mechanisms for multi level identification and verification. The stronger their identification and verification, the higher shall be their truth index or identification score. Initial identification or verification can be of type weak identification or strong identification; an example type of weak identification can be to provide contact information of example type address, telephone number, email etc; an example type of strong identification can be to provide physically or digitally proof of identification; an example type of strong identification can be to provide a copy of a valid passport duly attested by a legal authority. Said eco system 100 also provides mechanism for star ratings based identification; the higher the star ratings, the stronger the identification verification.

The informational eco system 100 also provides mechanism for the administrators of the said system 100 to create profiles for the users of type 200 and 300 to become authorized users. Authorized users can then post or retrieve data and information from the informational eco system 100. Individual data providers of the type 200 post data to the informational eco system 100 generally to earn compensation; business data providers of the type 200 post data to the informational eco system 100 generally to convey information and conduct transactions.

Data providers of type 200 comprising of individuals, organizations and government entities post data to the informational eco system and data consumers 300 generally retrieve and use data from the informational eco system 100 generally for payment. Data consumers 300 can be of example type individuals, organizations and government entities.

Data providers' 200 data can be subject to an access and usage fee, such data is called premium data. Generally transactional data offered by individuals and premium data offered by business and government entities is subject to an access and usage fee. Generally personal and confidential data is considered as toll data while premium data can be of type toll data and toll free data. At the discretion of the data providers 200, data and information can be accessed from the informational eco system 100 for zero payment; such payment free or zero payment data can also be accessed and used by temporary users. Both premium and payment free data and information searched and retrieved from the informational eco system 100 is subject to and is governed by the guidelines of the Internet eco system 1. Such guidelines are driven by the need for the profitability, well being and security of the providers of the Internet eco system 1 and those of the authorized and temporary users; guidelines of the Internet eco system 1 are subject to change.

System credits are credits offered to the authorized users of the Internet eco system 1 and can also be offered to the temporary users of the Internet eco system 1; system credits can be used in lieu of monetary consideration for data and information transactions. Access to certain types of premium data by temporary users may require such users to get verified by the Internet eco system 1.

The information eco system 100, by invoking the services of the application engine 110, enables authorized users of the type 200 to post data to a corresponding meta category; the meta category can be of type personal meta category, business meta category and government meta category.

A personal meta category can comprise of one or more subcategories of the example type but not limited to personal blog category, family history category, resume or profession skills category, pictures and videos category, market place category, ideas category, financial data history category, spending category medical history and medical data category, shopping trends category and personal and professional interests category, Internet downloads category and other user defined categories.

A business meta category can comprise of one or more subcategories of the type for profit business category and not for profit business category. The for profit business categories are generally sub categorized based on Standard Industrial Classification Codes; if a business category does not fall in any one of the Standard Industrial Classification Codes categories or one of their sub categories; it shall be mapped to a one or more closely resembling categories. Not for profit business data is defined as per their legal tax status granted by the legal taxing authority or any other legal national or international government body in whose jurisdiction such not for profit business operates. A government meta category can comprise of one or more subcategories comprising of local government categories, regional government categories, national government categories, and international government categories. All sub categories of meta categories can be further sub categorized or abstracted based upon need and convenience.

Data posting can be of the type freeform based posting, system forms based posting, keywords based posting, context based posting, constraints based posting, policies based posting, facts based posting, rules based posting, workflow based posting and or mathematical logic based posting of the example type Boolean operators. Authorized users of the type 300 can subsequently retrieve and use the data from the informational eco system 100 for a consideration. The consideration can be paid in money or system credits or can also be barter. An example of barter can be an user of example type 200 offers access to his or her toll data to a user of type 300 in exchange for a tangible or a non tangible product or service without the involvement of monetary consideration. System users of example type 200 can barter amongst themselves; system users of example type 300 can barter amongst themselves; system users of type 200 and 300 can also barter amongst themselves.

System users can barter for both types of data, namely informational data and transactional data. Data providers 200 can post data of the type of informational data and of the type of transactional data. Transactional data can also be for buying, selling, renting, leasing and all other forms of legal transactions. For example, a car for sale, a car for rent a car for lease a car for barter or a car for purchase. Payment consideration can be of the type of one time flat payment, a pay per access micro or macro payment, or periodic subscription payment, zero payment or barter based exchange. Payments involving monetary considerations can be in the common currency or multicurrency. Payment free data can be accessed by authorized and temporary users of the Internet eco system 1.

Data providers 200 can restrict access to their informational and transactional data; data providers 200 can also auction access to their informational and transactional data to the highest bidder; restricted users of the type 300 can bid for the restricted data. Data auction and data bidding can be for first use, exclusive use or non exclusive use. Data restrictions, auction and biddings have to be legal.

Data providers 200 may also post informational and transactional data to solicit bids from Data consumers 300. These solicitations can be in the form of closed solicitations or open solicitations. Open solicitations can be of the type of reverse auction bidding.

Authorized and temporary users search and retrieve the data and information from the informational eco system 100 by one or more combinations of the search and retrieval techniques provided by the search engine 130. The search can be of the type keyword(s) based search, mathematical operators based search, constraints based search, policy based search, facts based search, rules based search, workflow based search and/or context based search.

The toll and toll free data posted to the informational eco system 100 by the data providers 200 gets stored in the data store 170. The web services messaging communication module 150 facilitates communication amongst and between the various components of the informational eco system 100. The various components of the informational eco system 100 of the type of 110, 130, 150 and 170 can be housed at single site or at multiple sites; the multiple sites can be based in the same geography or can be disbursed across different geographies.

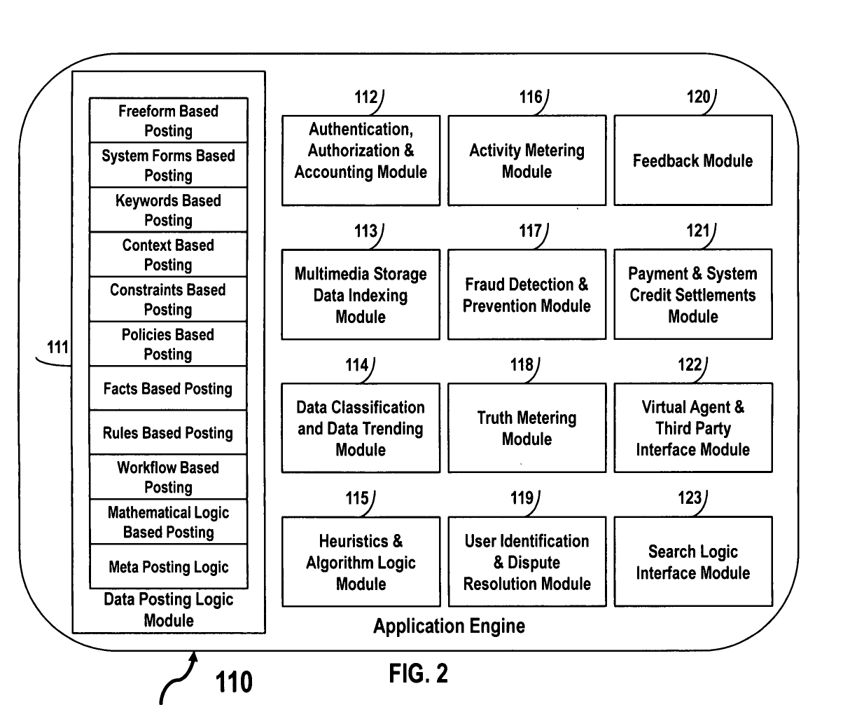

FIG. 2 illustrates an example application engine 110 of the Internet eco system 1. The application engine 110 comprises of several software and or software-hardware based logic modules; these include the data posting module 111, the authentication, authorization and accounting module 112, the multimedia storage and data indexing module 113, the data classification and data trending module 114, the heuristics and algorithm logic module 115, the activity metering module 116, the fraud detection and prevention module 117, the truth metering module 118, the user identification and dispute resolution logic module 119, the feedback module 120, the payment and system credits settlement module 121, the virtual agent and third party interface module 122 and the search logic interface module 123. The said modules of the application engine 110 communicate with each other and with the remaining software logic modules of the said Internet eco system 1 of the present innovation by means of the web services messaging communication module 150. The software and or software-hardware based execution logic of the application engine 110 in a certain instance may execute sequentially while in many instances may not execute sequentially.

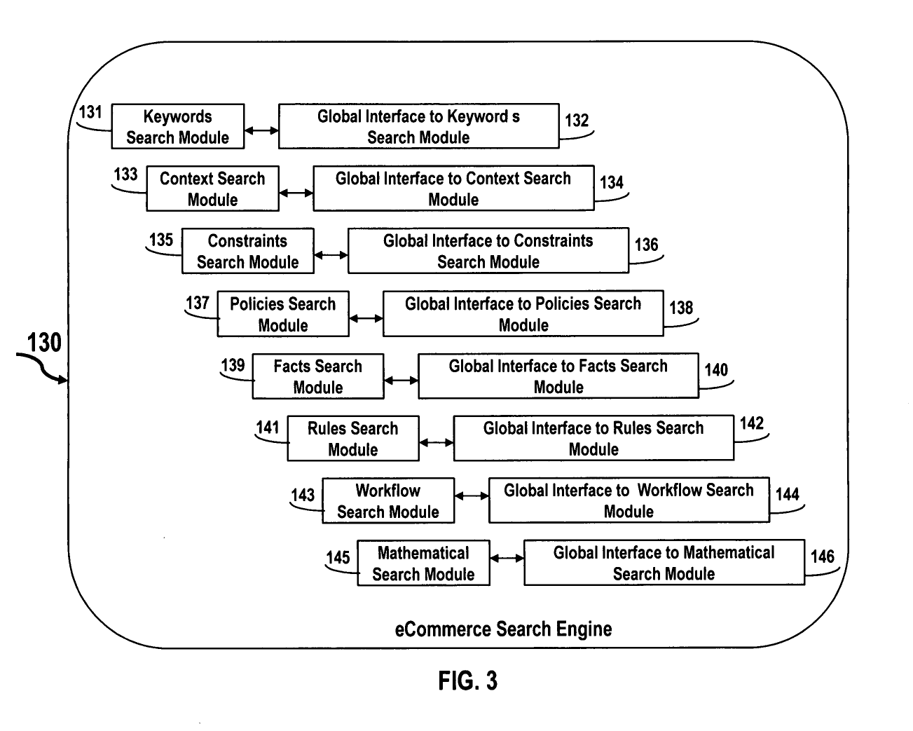

FIG. 3 illustrates an example search engine 130 of the Internet eco system 1. The search engine 130 comprises of several software and or software-hardware based logic modules; these include the keywords based search module 131 and the associated global interface to the keywords module 132, the context search module 133 and the associated global interface to context module 134, the constraints search module 135 and the associated global interface to constraints module 136, the policies search module 137 and the associated global interface to policies module 138, the facts search module 139 and the associated global interface to facts module 140, the rules search module 141 and the associated global interface to rules module 142, the workflow search module 143 and the associated global interface to workflow module 144 and the mathematical search module 145 and the associated global interface to mathematical search module 146. The said modules of the search engine 130 communicate with each other and with the remaining software logic modules of the said Internet eco system 1 of the present innovation by means of the web services messaging communication module 150. The software and or software-hardware based execution logic of the search engine 130 in a certain instance may execute sequentially while in many instances may not execute sequentially. The search engine 130 provides system templates for inputting keywords, context, constraints, policies, facts, rules, workflow and mathematical operations prior to or during executing search queries.

The virtual agent and third party interface module 122 of the application engine logic 110 facilitates interface to third party logic to input intelligence into the informational eco system 100 or extract and use the intelligence from the informational eco system 100. Such third party interface can be of manual type or can also be of automated type. For example but not limited to, a bicycle manufacturer who is not an authorized user of the informational eco system 100 provides inventory to bicycle dealers who are the users of the informational eco system 100. The bicycle manufacturer by interfacing with the services offered by the virtual agent and third party interface module 122 can query the informational eco system 100 for inventory status by submitting one or more types of search and retrieval queries to the search engine 130. Based on the results, for example, if the dealer inventory falls below a certain pre defined threshold, may ship certain quantity of inventory to the dealer and subsequently utilizing the services of the third party universal interface 122 post date of the type update dealer inventory.

The Virtual agent and third party interface logic module 122 also contains logic for system users to create virtual agents that can transact on their behalf. It also enables system users of the type 200 and 300 of the meta sub categories of business type and government type to create virtual agents for their vendors, partners and suppliers and subscribers who are not the users of the informational eco system 100 to interact with their data residing on the informational eco system 100. Furthermore, the said virtual agent of the virtual agent and third party interface module 122 can be programmed to retrieve pertinent information from the informational eco system 100 and also from the open Internet 400.

The mathematical posting logic sub module of the data posting logic module 110 also offers well known database functionality for informational eco system 100 data manipulation of the example type but not limited to update, delete, modify, rollback etc. Said sub module also offers mathematical functionality of the example type Boolean operators. The data posting logic module 110 also offers functionality to assign weight ratings of the example type numerical ratings or star ratings to the data being posted. For example a data provider 200 posting resume with a high degree of industry experience and relevant educational background will get a higher numerical weight or star rating than a data provider 200 posting resume with a lesser degree of industry experience.

When data providers 200 and data consumers 300 access the informational eco system 100 of the Internet eco system 1 of the present innovation, the informational eco system 100 provides an option for authorized users to login to the said eco system 100. Authorized and temporary users can also chose to use the no payment services without logging into the informational eco system 100. During login by the authorized system users of the type 200 and 300, the application engine 110 invokes the logic of authentication, authorization and accounting module 112 to authenticate, authorize and validate the account status of the authorized users. The accounting logic of the authentication, authorization accounting module 112 by leveraging the ratings of the data trending module 114 may also establish a monetary or compensation value of the data posted by the data providers 200 in the informational eco system 100. For example, the cost to access the profile of a data provider 200 of the type consumer whose yearly income may exceed $100,000. The accounting module 112 also provides accounting capabilities to the transactions conducted in the Internet eco system 1. An example type of the accounting function may be to display the compensation earned by the data providers 200; another example type of an accounting function may be to display the amount spent by data consumers 300 for accessing the information provided by data providers 200.

Many embodiments of the authentication, authorization and accounting logic module 112 are unique to the present innovation. For example, the Informational eco system 100, based upon system heuristics of the example type of the activity index score, the truth index score, the frequency, value and size of the transactions etc. may challenge the authorized system users of the type 200 and 300 to enter or present specific time-stamped system identification to login to the system. Any system based challenge data of the example type of the activity index score, the truth index score etc. can be provided to the authorized users in a secure manner.

Upon successful login to the informational eco system 100, the authorized users are presented with a dashboard which amongst other information list authorized users' activity score, truth index or score, data transaction information (amount earned, number of transactions) etc. The dashboard screen may also provide click buttons with embedded functionality to interact with the said eco system 100 for data posting and data search and retrieval.

The informational eco system 100 may choose to present advertisements to the authorized and temporary users before they log into the informational eco system 100; advertisements can also be presented to authorized users after login. Authorized and temporary users can interact with compensation based advertisements but only authorized users are privileged to earn monetary compensation for such advertisements. Temporary users can also earn advertisement compensation by performing certain buy transactions using their credit card, debit card or by using other forms of instant payments such as check by phone, check by Internet, or other payment schemes such as but not limited to PayPal etc. The earned compensation, based upon payment schedule, will be sent to such users either instantly or periodically. The informational eco system 100 may also offer compensation to system users for interacting with the advertisements and may also offer compensation for watching advertisements passively.

Examples of watching passive advertisements may include system users watching advertisements as they navigate thru the pages of the Informational eco system 100.

Example of interacting with advertisements can include clicking on passive advertisements that are being displayed as systems users navigate thru the Informational eco system 100 and conduct transactions with such advertised product or service. Yet an additional example of interacting with the advertisements can be system users accessing their advertisement inbox and open and watch advertisements sent to their advertisement inbox.

The Informational eco system 100 has the capability to gather and collect all information provided by temporary users to automatically create their profile and solicits all temporary users of the said Internet eco system 1 to become authorized users by providing additional verification and identification information.

The informational eco system 100 enables authorized users of type 200 to post their data and information in one of many posting techniques; they can subscribe to a variety of services of data posting logic module 111. The data posting software logic module 111 of application engine 111 provides system templates for posting data in one or more data posting formats; the said posting can be freeform based posting, system forms based posting, keywords based posting, mathematical logic based posting of the example type Boolean operators or database operations, constraints based posting, policy based posting, facts based posting, rules based posting, workflow based posting and or context based posting.

In freeform based posting, the Informational eco system 100 provides mechanisms for the system users to post personal, confidential and business data in free form. An example of freeform based posting can be uploading of files containing personal, confidential and business data into the Informational eco system 100.

In system forms based posting, the Informational eco system 100 provides a variety of forms based mechanisms for the system users to post personal, confidential and business data. Examples of system form based postings can be postings of profiles, ideas, pictures, videos, resumes, business plans and drawings etc. utilizing the forms provided by the Informational eco system 100.

In keywords based posting; the data posting logic module 111 of the application engine 110 constructs an index by utilizing the services of the heuristics and algorithms logic module 115, of all non common words; common words are of the example type definite and indefinite articles, prepositions etc. Based on the past frequency of their occurrence, given category of data, the frequency of keyword specific search and other criteria, the algorithm module 115 assigns a weight to each word, subsequently the context based sub-module of the data posting logic module 111 provides a context for the word in which it occurred. Next, the score of the word in the appropriate context index is increased according to its weight. Similarly, when data is modified or deleted from any files stored in the Data Store 170, the context sub module of the data posting logic module 111 with the assistance of services of the heuristics and algorithms logic module 115, identifies the weight of the keywords that are modified and or deleted and correspondingly increases or decreases the score of the appropriate keyword index and context index category. For example, if the word “disc” occurred in a new data posting in the context of a computer compact disc; based upon the weight computed by the algorithms module 115, the context index of the category of computers sub category storage accessories and the keyword index score of the word disc is increased by the corresponding weight. If however, the word “disc” occurred in the context of a spinal disc joint, based upon the weight computed by the algorithms module 115, the context index of the category of human body, sub category joints, sub category spine and the keyword index score of the disc is increased by the corresponding weight.

The said informational eco system 100 also provides data providers 200 to post data based on user defined and or system defined constraints by means of invoking the services of sub module constraints based posting of the data posting logic module 111. For example, for the data about spinal disc joints, the constraints can be of the type of male or female, infant, toddler, adolescent or adult, large body build, or medium body build or small body build, age group, race and ethnicity etc. Data providers 200 data can then be posted as per the user suggested or system provided constraints. For all such policies based postings, the data posting logic module 111 maintains a constraints index.

The said informational eco system 100 also provides data providers 200 to post data based on user defined and or system defined policies by means of invoking the services of sub module policy based posting of the data posting logic module 111. For example, for the data about computer compact discs, the policies based posting can be subject to policies such as not to accept data posting from data stored on user burned compact discs, or to check for copyright violations. Data providers 200 data can then be posted as per the user suggested or system provided policies. For all such policies based postings, the data posting logic module 111 maintains a policies index. The said informational eco system 100 also provides data providers 200 to post data based on user defined and or system defined facts by means of invoking the services of sub module facts based posting module of the data posting logic module 111. For example, for the data about spinal disc joints, the facts can be percentage of complete recovery of injured people involved in a frontal vehicle accident moving between 10 and 20 miles, between 21 and 30 miles, between 31 and 40 miles an hour etc. Data providers 200 data can then be posted as per the user suggested or system provided facts. For all such facts based postings, the data posting logic module 111 maintains a facts index.

The said informational eco system 100 also provides data providers 200 to post data based on user defined and or system defined rules by means of invoking the services of sub module rules based posting module of the data posting logic module 111. For example, for the data about spinal disc joints, the rules based data posting can be of the example type spinal disc joint injuries occurring to dogs in moving vehicle accidents for one breed of dog can apply to apply to all breed of dogs. Data providers 200 data can then be posted as per the user suggested or system provided rules. For all such rules based postings, the data posting logic module 111 maintains a rules index.

The said informational eco system 100 also provides data providers 200 to post data based on user defined and or system defined workflow by means of invoking the services of sub module facts based posting module of the data posting logic module 111. For example, for the data about spinal disc joint surgeries of adults over the age of 50 involved in car accidents a common surgery workflow can be defined for the most effective way to operate. Data providers 200 data can then be posted as per the user suggested or system provided workflow order and components. For all such policies based workflow postings, the data posting logic module 111 maintains a workflow index.

The said informational eco system 100 also provides data providers 200 to post data based on user defined and or system defined mathematical model by means of invoking the services of sub module facts based posting module of the data posting logic module 111. Example type of mathematical based posting can of type Boolean operators or of the type database based operations.

Based upon the context of data providers' data, the data posting logic module 111 of the application engine 110 offers various templates described in the present innovation to post their data; data of certain context may qualify for all data posting techniques while other forms of data based on their context may not qualify for all forms of posting. For example, data about job applicant's resume may not qualify for workflow based posting but may qualify for keywords, context, policies, facts and rules based posting. Data providers 200 can elect the informational eco system 100 to post their data based upon said system's defined templates. Generally, context applies to all types of data postings described. The data posting logic module 111 maintains either a common or can also maintain a distinct context index for the various types of the data postings described.

A unique novelty of the present innovation involves learning of user behavior by the informational eco system 100 by utilizing the services of the data classification and data trending module 114, the heuristics and algorithm logic module 115 the activity metering module 116, the fraud detection and prevention module 117, the truth metering module 118, the user identification and dispute resolution module 119, the feedback module 120, the payment and the system credit settlement module 121. The data posting logic module 111 obtains the feedback from these various modules to suggest hybrid forms of data posting techniques to authorized system users. The informational eco system 100 also constructs hybrid data posting modules based upon its many subsystems and can auto assist users to post data based upon such hybrid posting module. The data posting logic module also maintains and manages a meta posting logic subsystem which stores the meta data of all the posting schemes. When users of the type 300 requests search and retrieval to be performed of various types described in the search engine paragraphs of the present invention, the search engine 130 subsystem by means of the services of the search logic interface 123, assists the search engine 130 to locate the most relevant data and information requested.

The multimedia storage indexing module 113 working in unison with the meta posting logic subsystem of the data posting logic module 111, stores user data and information in the data store 170; said storage indexing module 113 also retrieves data and information when requested by the search engine 130 sub assembly.

The data store 170 comprises of data storage logic and informational eco system 100 data.

The data classification and data trending module 114 classifies text, pictorial and multimedia data based upon the various posting templates of the data posting logic module 114; it also captures, monitors and creates intelligence about the data based upon the data and information postings, data usage and transaction trends by the authorized users of type 200 and 300.

The heuristics and algorithms module 115 is a repository of mutating algorithms which provides mathematical modeling for data posting techniques, data search technique, fraud detection and prevention, truth metering and feedback generation in particular and other allied services in general.

The activity metering module 116 tracks and monitors user activity of the type 200, 300 and of the type temporary users. The said module 116 also monitors and reports informational eco system's 100 efficiency, usage and performance status. The fraud detection and prevention module 117 and the truth metering module 118 use the information and data provided by the activity metering module 116 to prevent and detect fraud and to compute the truth index of system users of the type 200 and 300. For example, the activity metering module reports to the fraud detection and prevention module if it determines that an example user of the type 200 accesses the informational eco system and made unusual data posting transactions or other types of transactions normally not performed by the user. Another example can be an example user of the type 300 frequently accesses the informational eco system 100 and changes the identification and profile information; the activity metering module 116 reports the activity of the said example user of type 300 to both the fraud detection and prevention module 117 and the truth metering module 118. The truth meter or the identification index can also be computed based upon the identification credentials provided by the data providers 200. Submission of a duly attested or notarized copy of the example type of a passport, driver's license or a state issued identification card carries a higher truth meter score versus the submission of the same forms of identification credentials without being duly attested or notarized.

The fraud detection and prevention module 117 in unison with the truth metering module 118 plays a vital role in maintaining the safety and integrity of the informational eco system 100. It obtains all suspicious information from the activity metering module 116 and based on its novel logic determines the fraud risks and takes all appropriate prevention measures. For example, an user of the example type 200 uses correct system login credentials and access the informational eco system 100; however another user of the example type 200 attempts to access the informational eco system 100 using the same access credentials while the first user of the said example is still logged into the informational eco system 100. The authorization, authentication and accounting module 112 and the activity metering module 116 immediately alerts the fraud prevention and detection module 117. Said module 117, using one of the several fraud detection criteria, compares the Internet address of both the users to determine which of the two Internet addresses are in the proximity of the geography normally used to access the informational eco system 100. The fraud detection and prevention module 117 can then take one or more measures to isolate, reduce and eliminate the risk to the integrity of the informational eco system 100; said fraud detection and prevention module can instruct the authorization, authentication and accounting module 112 to terminate the access of both users, or flash a security notice on the screen of the user who accessed the informational eco system 100 from the normal geography and then disconnects said user access from the informational eco system 100. The security notice can be of the example type informing the user to call a telephone number to identify themselves. The fraud prevention and detection module 117 can also instruct the authentication, authorization and accounting module 112 to terminate the connection of the user who accessed the informational eco system from an unusual geography or it can inform the data posting logic module 111 to lock down access to posting templates for the said user, lock up all transactional functionality and instructs the multimedia storage module 113 not to store and retrieve data for the said user and can also inform the search engine module 130 not to accept toll and toll free data and information transaction requests from said user while displaying to said user certain information to click or navigate in ways to provide more information to identify themselves. Meanwhile if the authorized user calls a telephone number provided by the informational eco system 100 and identify themselves, or the informational eco system 100's provider contacts the example user to identify their identification information and validate their activities, the fraud prevention and detection module 117 establishes a fraud has been committed and is in progress and takes other appropriate actions to minimize the risk to the integrity of the informational eco system 100.

For example, the informational eco system can inform the fraudulent user to identify their physical address to receive certain instant monetary or system credits or visit a certain business or undercover public or private law enforcement entity for rewards collection.

The user identification and dispute resolution logic module 119 can establish authorized and temporary user identification and dispute resolution by digital means or physical means or a combination of both. The user identification and dispute resolution module 119 plays a vital role in establishing the true physical and digital identities of the authorized users and temporary users of the Internet eco system 1. For example, during sign-up the informational eco system 100 may prompt the user to enter their government issued identification credentials or may also prompt users to visit the informational eco system 100 provider's physical identification locations for identification, authentication and validation. The credentials can be based on but not limited to government issued credentials such as a government entity issued identification cards, driver license, passport etc. or can be of example type of a global private identification agency issued credentials or of the example type financial institutions issued credentials or can be of example type credit rating institute credentials or can be of type biometric identification. The biometric identification and validation can be based on but not limited to finger prints, blood type and retina scans etc.

The truth metering module 118 utilizes the credentials provided by the user identification and dispute resolution module 119 to compute the truth index or score of system users of type 200 and 300. The truth index or score of temporary users can be based on their digital credentials of the type but not limited to financial issued credentials, government issued credentials, private credit rating issued credentials etc. The truth metering module 118 also utilizes the credentials provided by the feedback module 120.

The truth metering module 118 uses one or more criteria to establish the true identity or the truth index of the user types 200 and 300. The authorized users' truth meter index can be of numeral type or classification type. The numeral type can be a score on a defined numerical scale, for example, 1 thru 10, 1 thru 100 or 1 thru 1000 etc. The classification types can be of example type weak, intermediate, strong and very strong truth type etc. or can be low, medium, or high truth type. The truth metering index reflects several criteria including but not limited to the identification of authorized users based upon their credentials and biometrics. The credentials can be based on but not limited to government issued credentials such as government entity issued identification cards, driver license, passport etc. or can be of example type of a global private identification agency issued credentials. The biometric identification and validation can be based on but not limited to finger prints, blood type, and retina scans etc. The truth index of authorized users of the Internet eco system 1 can also be based on transaction history of the users of the example type 200 and 300 and feedback provided by other users of the example type 200 and 300. The index or score computed by the truth metering module 118 can be used by authorized and temporary users of the Internet eco system 1 to base their judgment of a given authorized user; the judgment can be of example type credibility, honesty, sincerity, credit worthiness, transaction worthiness, skills worthiness, medical worthiness, capabilities and future abilities etc. The truth index established by the truth metering index 118 can be of the type abstract or granular. Examples of abstract types can be but not limited to low, medium and high or weak, intermediate or strong. The granular index type can be based upon an index range for example 1 thru 100 of physical characteristics of the user. The physical and non physical characteristics of system users can be used together to establish a unified form of identity or truth index of the authorized users of example type 200 and 300 or can be used separately to establish several truth indices of the authorized users of example type 200 and 300. The truth meter or truth or identification index of authorized system users of the Internet eco system 1 can be used in unison or in individuality to establish judgment about said authorized users of the Internet eco system 1. For example, a government agency of the type military agency may use the truth index of the type medical truth index to identify army recruits. Another example of a truth meter score can be utilized in conducting informational data based transactions and transactional data based transactions. In case of informational based data based transactions, the transacting party can rely on the truth index to determine whether or not to conduct the transaction; similarly in transactional data based transactions, the truth meter score can be relied upon to consummate the transactions with confidence The truth index or score computed by the truth metering module can be called by any name convenient to the owner and provider of the Internet eco system 1. Certain components of the computed truth index by the truth metering module can be fixed while certain components can be variable; the variable components can vary on an ad hoc basis or can vary periodically; the variable nature of the truth index or identification score can be based on several physical and non physical criteria. The example type of fixed truth index can be based on but not limited to the blood type of an authorized user of example type 200 or can be based on but not limited to the inception or formation date of an authorized user of example type 300. The variable components of the truth index can be based on but not limited to credit worthiness of authorized users and temporary users.

The feedback module 120 obtains and collects and maintains feedback of authorized and temporary users of the Internet eco system 1 for the benefit of the informational eco system 1, and that of authorized and temporary users. The feedback can be of the example type but not limited to feedback on the identification credentials submitted to the Internet eco system 1, product usability feedback provided by system users or feedback on the skills and abilities of an authorized user 200 of the type of a job seeker. Authorized users of the type 200 who may be a business employer or a government employer can provide feedback on job seekers who worked for them previously and authorized system users of the type 300 can then use this feedback to make a hiring decision based on this feedback. In this example, the authorized users of the type 200 who may be a business employer or a government employer gets a financial incentive or system credit when job related feedback information about their former or current employees is provided and accessed by users of the type 300. The feedback module also tracks and maintains feedback on the credit worthiness of the authorized users of the type 200 and 300. For example, authorized user of the example type 200 may offer tangible and non tangible items for sale and authorized users of example type 300 may purchase such tangible and non-tangible items. The feedback module can then collect feedback from both types of users of their transaction payment experience. The heuristics and algorithms logic module 115 can then compute and provide a feedback transaction score to the truth metering index to update its granular credit worthiness related truth index or score of the authorized users of the example 300.

The fraud prevention and detection module 117 also uses the services of the feedback module 120 in the detection and prevention of fraud. When system users of the type 200 and of type 300 commit fraud, the indexing scoring algorithm computes a fraud index or score of such fraud, the truth metering module then updates its abstract or granular truth index to reflect such fraud. Frauds can be of the type unintentional type and intentional types.

The Internet eco system 1 rewards authorized users of type 200 and type 300 with zero or no fraud history. Theft and inappropriate use of personal and professional information is strictly monitored and controlled by the informational eco system 100. User feedback of authorized users and temporary users plays a vital role in management of truth throughout the Internet eco system 1. The foundation of truth is laid with the data postings; accuracy of data providers' data of the type 200 and 300 enables them to participate in financial transactions of greater and greater value. The truth index computed with the aid of many subsystem logic modules of the informational eco system 100 provides universal clarity of the accuracy of data throughout the informational eco system 100. The informational eco system provides room for the input of ambiguous data and information, all such information has to be clearly identified; the data classification and data trending module 114 of the application engine identifies incorrect information traits deduced from the informational analysis algorithms of the heuristics and algorithms logic module 115. As the user traffic of the Internet eco system 1 grows, the data classification and data trending module 114 begins to generate truth patterns of user data; it starts with the signup profile beginning with a minimal set of probing questions until the minimal truth score of the truth metering module is reached. User identification as described in preceding sections always plays an important role in computing the identification credibility or the truth index of users.

The Internet eco system 1 offers system credits for users to reach the minimal truth threshold levels such as to begin earning revenues for their data postings. The feedback module 120 acts as an IRS truth agency; fraud reporting is diligently investigated by the fraud prevention and detection module 117; Users of the type 200 and 300 adversely impact their truth index or score by false claims of fraud and frivolous allegations. Once the fraud prevention and detection module 118 certifies the validity of a fraudulent report or fraudulent activity detected by the informational eco system 100; the truth index of the said user is negatively impacted. Negative truth index rankings is generally available to all authorized and temporary users of the system who may be interested in conducting an information or data transaction with a negatively impacted truth index user; the Internet eco system provides mechanism to present fraudulent incidents prior to the initiation of transactions. The feedback logic module 120 also provides risk ratings of authorized system users; the payment and system credit settlement logic module 121 provides the credit worthiness index of authorized system users; said logic module 121 also interfaces with accounting logic of to settle payment and system credit between transacting users.

Frauds committed by the authorized users of the Internet eco system 1 can be of the example type civil frauds and can also be of the example type law enforcement type; civil and law enforcement frauds adversely impacts the truth metering 118 score of the authorized users.

Upon reaching the minimal threshold truth level authorized data providers 200 can begin to earn revenues and or system credits; the minimal truth threshold level can have variable thresholds for various users. For example, for users of type 200 and 300 in certain geography to reach the minimal truth index level, they may have to submit a government issued ID duly certified by a legal attesting agency. The geographical area can be as granular as the authorized user's street address and can also be as global as to cover the authorized users of the entire planet earth.

Data postings of the type resume by job applicants of example type individual can earn compensation based on the usage of their resume; the resume information can also be used to gain lawful employment. A resume followed by copies of education credentials directly sent from the education institute along with duly certified government issued ID can be a criteria set by the user identification and dispute resolution module 119 to reach the minimum threshold level for job applicants. Current or former employer feedback can add a star rating to the truth index of such job applicants of type 200. When data consumers 300 access resumes of individual data providers 200 which has their current or former employer feedback along with their educational credential information in the informational eco system 100; they may be required to pay a higher access fee to access such information.

Duly investigated and certified feedback of the example type but not limited to a feedback from current and former employers about employee performance by means of the feedback module 120 adds a star rating to the truth index or score of the authorized users of type 200; the star ratings substantially improves the truth score of authorized users of type 200 and of type 300. Authorized users of the type 200 who may be a business employer or a government employer can post example data of the type employee personal file for an access fee. The informational eco system 100 provides mechanisms for data providers to limit or increase visibility into their data postings.

The user identification and dispute resolution logic module 119 provides dispute resolution arbitration by interfacing with the civil arbitration services of regional, national or international jurisdiction; the dispute resolution entities used by the user identification and dispute resolution logic module 119 of the application engine 110 can be of the example type private entities, public entities, or a combination of private and public entities. Such dispute resolution entities can be autonomous, semi autonomous or entities under the control and supervision of the Internet eco system's 1 provider.

The informational eco system 100 also facilitates the collection of transaction facts between system users of the type 200 and 300. For example, but not limited to, an authorized user of type 200 in retail business can provide compensation based advertisements to authorized users of the type individual users; the compensation can be of example type percentage off for purchasing the advertised item within a specified time and geographical location. Upon purchase of said item or items, a fact is established; the transaction facts can be collected for tangible and non tangible inventory between system users.

The virtual agent and third party interface module 122 provides systems hooks to bring in or connect third party functionality, services and solutions provided by the suppliers, vendors and partners of the Internet eco system 1. The policy and criteria for all such third party interface is governed and dictated by the global system policies of the Internet eco system 1.

The search engine interface logic module 123 interfaces with the search engine 130 of the informational eco system 100.

The web services messaging communication module 150 facilitates the communication between the intra subsystem components of the type the application engine 110, the search engine 130 and the data store 170. The said messaging communication module 150 also facilitates communication between the main components of the informational eco system 100 namely between application engine logic module 110 and search engine logic module 130; between application engine logic module 110 and data store 170 and between search engine logic module 130 and the data store 170.

The data providers of example type 200 can access the informational eco system 100 from anywhere and at any time.

The data classification module and data trending module 114 provides mechanism for data providers of type 200 to post data in one or more categories as described in earlier paragraphs. The posting of inappropriate content will be subject and governed by the policies of the Internet eco system 1.

The search engine logic module 130 enables authorized and temporary users to search and retrieve data to aid in conducting informational data based transactions and transactional data based transactions utilizing the services of one more sub system logic modules of the search engine 130. The keyword based search module 131 fetches data based on key word search from the informational eco system 100 by performing a lookup of the keyword index composed and maintained by the keyword based logic subsystem of the data posting logic module 110.

The associated global interface to keywords module 132 fetches the most relevant data based on key word search from the open Internet 400. Said keywords module 132 utilizing the services of web spiders, web crawlers and other data suction technologies builds an exhaustive index using techniques of the data posting logic module 111 of keyword referenced web pages, web sites, ftp sites, user groups and all other types of Internet resources and destination of the Internet 400. The informational eco system 100 provides mechanisms for authorized system users and temporary users to specify if they want to perform the associated open Internet 400 search; in the event the systems users prefer not to perform an open Internet 400 search, the informational eco system perform such searches in the background to build the keyword index repository of the global interface to keywords module 132.

For example, an authorized user of the example type 200 seeks employment opportunities of the example type “java project management” and performs a keyword based search 131 in association with a mathematical operator 145 of the example type of a Boolean operator AND the resulting Boolean operator based search query resembling of the example type “Java AND Project Management” without any further qualifiers.

In executing the example search query on the data available in the informational eco system 100, the search engine 130 applies the profile of the said example user 200 to the indices of the data posting logic module 111 to filter and display all java project management job openings. System qualifiers of the type geography, distance, date, time etc. and intelligence provided by the activity metering logic module 116, feedback logic module 120 and by third party interface logic module 122 can also be applied to all search queries for precision filtering of search results.

The informational eco system 100 may also permit the search engine 130 to execute the said example search query on the public Internet 400. In this example type, the search engine 130 executes the search query on the one or more global indices for example the index of the global interface to keywords module 132, the global interface to constraints indexing module 134 etc. to filter and display the most relevant job openings available on the open Internet 400. System qualifiers, intelligence provided by the activity metering logic module 116, feedback logic module 120 and by third party interface logic module 122 can also be applied to all open Internet 400 based search queries for precision filtering of search results.

Another example can be a system user of the Internet eco system 1 may want to purchase an item of the example type a television set from other users of the Internet eco system 1. The search engine logic module 130 will search and retrieve all such television sets offered for sale on the Internet eco system 1, the search engine logic module with associated interfaces to the Internet 400 can also find all such television sets offered for sale on the open Internet 400. The system user can then compare the search results from the Internet eco system 1 with the search results from the open Internet 400. The providers of the Internet eco system 1 can restrict system user search only to the informational and transactional data available in the informational eco system 100 or can allow users to conduct comparative searches on the open Internet 400 or can also offer a hybrid search capabilities for specific types of informational data based transactions and or transactional data based transactions.

The context search module 133 of the search engine logic 130 provides context to search queries in the informational eco system 100 environment and also in the open Internet 400 environment. In searching relevant context information based on system user queries, the context search module 133 by invoking the services of the search logic interface 123 applies the search query to the context index generated and maintained by the context based posting logic subcomponent of the data posting logic module 111 to extract and present relevant contextual information from the informational eco system 100. The global interface to context module 134 gathers and maintains context intelligence for the information available on the open Internet 400. Similar to the context index maintained for the various types of data postings as described in previous paragraphs by the data posting logic module 111, the global interface to context search module 134 also builds and maintains context index for all types of search and retrieval queries such as keyword search queries and search queries described in the subsequent paragraphs that are executed on the open Internet 400. Open Internet 400 based search and retrieval queries are executed against these indices.

The constrains search module 135, the policies search module 137, the facts search module 139, the rules search module 141, the workflow search module 143 and the mathematical search module 145 applies the corresponding index logic of the data posting logic module 110 to said type of search queries on the data available in the informational eco system 100.

The global interface to keywords search module 132, the global interface to context search module 134, the global interface to constraints module 136, the global interface to policies search module 138, the global interface to facts search module 140, the global interface to rules search module 142, the global interface to workflow search module 144 and the global interface to mathematical search module 146 by means of web crawlers and web spiders gathers information and builds respective type of exhaustive indexing to the information available on the public Internet 400. Search queries performed on the open Internet 400 by authorized users of the type 200 and 300 and temporary users execute against one or more of the indices mentioned in this paragraph to display the open Internet 400 based search results. The informational eco system 100 applies the profile intelligence of the authorized users of the type 200 and 300 when executing public Internet 400 based search queries on their behalf for results relevancy and precision.

System users of the Internet eco system 1 can perform facts based searches; users can be of type 200, 300 or temporary users. For example, a business user of the type 200 may want to verify the fact that a certain promotional advertising on the informational eco system 100 generated tangible results. The informational eco system 100 by virtue of many of its logic modules as described in the present innovation monitors and keep tracks of facts, in this example type, transaction facts that occurred in the informational eco system's environment. The informational eco system 100 provides a detailed report in response to the example fact search query substantiating the facts; the facts search result report can be of abstract nature or can be of type detailed nature. The example user of type 200 conducting a fact search query may have to pay an access fee to view deep into the data and information of system users who transacted with said user of type 200.

System users of the Internet eco system 1 can perform workflow based search and retrieval queries; workflow search and retrieval queries can be of example type but not limited to seeking to perform specific tasks based on and conforming to the workflow of a business entity. For example, an authorized user of the type 200 of subtype of a government entity utilizing the workflow template of the informational eco system 100 inputs its workflow to determine an individual or a business entity to perform certain work item conforming to its workflow; the informational eco system 100 executes the workflow search queries by submitting to the heuristics and algorithm logic module 115 of the application engine 110; said heuristics and algorithm logic module 115 internalizes the indices of the data posting logic module 111 to filter and determine the most relevant individual or business entities in order of their ability to perform said work conforming to the workflow model of the said example government entity.

System users of the Internet eco system 1 can perform simple or complex mathematical operations based search and retrieval queries on the data available in the informational eco system 100 or on the public Internet 400. Boolean operators based search and retrieval queries is an example of mathematical operations based search and retrieval queries.

System users of the Internet eco system 1 can perform policy based search and retrieval operations to extract data corresponding specific policies, for example but not limited to, the policy of a state government is to permit digging of new irrigation wells in its jurisdiction within certain confined areas of the state; the system of the present innovation provides the posting of data based on such policies and the retrieval of data on such policies.

System users of the Internet eco system 1 can perform rule based search and retrieval operation to extract data corresponding to specific rules, for example but not limited to, determine the number of violators of specific driving rules, for example driving 20 miles over the speed limit on all national highways on a particular holiday. The system of the present innovation provides the posting of data based on such rules and the retrieval of data on such rules.

System users of the Internet eco system 1 can perform constraints based search and retrieval operation to extract data corresponding to specific rules, for example but not limited to, determine the number of tests a drug has to pass prior to it can be deemed safe. The system of the present innovation provides the posting of data based on such constraints and the retrieval of data on such constraints.

The present innovation of the Internet eco system 1 provides for search and retrieval queries to be executed against the informational eco system 100 and also against the public Internet 400.

For all search and retrieval queries, whether performed on the informational eco system 100 or on the public Internet 400, the informational eco system provides mechanism to apply system qualifiers of the type geography, distance, date, time etc. and intelligence provided by the activity metering logic module 116, feedback logic module 120 and by third party interface logic module 122.

With the aid of the search engine logic and the system components as described in the preceding paragraphs, the Internet eco system 1 of the present invention enables system users including Consumers, Corporations and Government entities based upon the posting of their informational data to earn compensation and or other barter benefits by sharing their personal, confidential and business data. Example types of such beneficial transactions are described in subsequent paragraphs.

A data provider 200 of type consumer accesses the Internet eco system 1 and posts his or her personal data—the personal data may comprise of his or her profile, resume, identification credentials, pictures, videos, etc. The said user may also post certain sensitive or confidential information such of the example type of intellectual ideas, health information, their spending information and financial information, etc; The data providers 200 of the type of for profit corporations, not for profit corporations and government entities can also post personal confidential and business information about their respective organizations including intellectual property and intellectual ideas; Said data providers 200 of the types of consumers or of the type of an organized for profit, not for profit or government agency may also indicate a price for accessing their data by data consumers 300. The Internet eco system 1 of the present invention by means of the Data Classification and the Data Trending Module 114 assigns ratings to the data.

A data consumer 300 of type of a retail business may want to access the user data to determine what product and services can be sold to the data provider 200 of the example type consumer. The Internet eco system 1 provides mechanisms for the data consumer 300 of the example type retail business to search target customers based upon one or more search example types described in the present invention. The such results will be organized in a convenient and easy to understand format for the data consumer of the type 300 to make business decisions; this may include such criteria but not limited to the data ratings established by the data classification and the data trending module 114, the truth meter ratings established by the truth metering module 118, the cost associated for inspecting the retrieved data in detail established by the accounting module 112. Should the data consumer 300 of the example type retail business chooses to inspect the search results, the Internet eco system 1 charges the data consumer 300 an appropriate amount as established by the accounting module 112. The Internet eco system 1 of the present invention credits a fractional percentage or the entire amount earned to the data provider's 200 account. Accordingly, the accounting module 112 charges the data consumers 300 for accessing and using the data providers' data. In another example embodiment, data providers 200 of the example type of for profit corporations, non-profit corporation and government entities post their confidential and business data for barter or to earn compensation; data consumers 300 of the type of for profit corporations, not for profit corporations and other government entities may access and use such data for a compensation or barter of products and services.

In the above two examples, data providers 200 can also be data consumers 300 and vice versa A data provider 200 of the consumer type can search and seek data and information on other data providers 200 of consumer types thus becoming a data consumer 300 while also remaining as a data provider. An embodiment of this example is a single woman who has created a profile in the Internet eco system of the present invention and provided additional confidential data about herself with the aim of earning compensation—the informational eco system 100 thus categorizes her as a data provider 200. Subsequently she decides to search and seek eligible bachelors in the Internet eco system 1 to find a suitable male for marriage. She is now a data consumer 300 of type consumer while also being a data provider 200.

The Internet eco system 1 by means of the embedded logic of the informational eco system 100 also provides means for data providers 200 of the consumer types and also of the types of for profit corporations, not for profit corporations and government entities to post transactional data to engage and conduct in compensation based transactions.

The Internet eco system 1 by means of the embedded logic of the informational eco system 100 provides means for data providers 200 of the individual or consumer types and also of the types of for profit corporations, not for profit corporations and government entities to post their specific and particular transactional data requirements with or without utilizing the posting templates provided by the application engine logic 110. Users of the Internet eco system 1 can then bid to service the requirements of such data providers. Two examples of this embodiment are described as follows:
1. A data provider 200 of the type individual or consumer may post his or her requirement in the Internet eco system for a specific type of a car of an example type Toyota Camry for purchase. The informational eco system 100 provides means for other data providers 200 of all types and data consumers 300 of all types to search and submit bids to sell a Toyota Camry to the original data provider 200 soliciting bids for a purchase of a Toyota Camry. The informational eco system 100 may categorize such solicitations as reverse bidding.
2. A data provider 200 of the type of a for profit corporate entity may post a specific requirement in the Internet eco system 1 for specific types and numbers of cars for purchase. The informational eco system 100 provides means for other data providers 200 of all types and data consumers 300 of all types to search and submit bids to meet the requirement of such a for profit corporate entity. Likewise in a reverse bidding system of the present invention, data consumers 300 of all types can also post their needs and requirements in the Internet system.

The Internet eco system 1 also provides mechanisms for temporary users to conduct searches and engage in informational data based transactions and transactional data based transactions.

The payments and system credits settlement module 121 may provide services for the settlement of payments and or system credits; outside payment and settlement providers may also provide services for payment settlement for the transactions conducted in the Internet eco system of the present invention.

The Internet eco system 1 provides a means for data providers 200 and data consumers 300 to conduct a variety of transactions including but not limited to social networking to participate and consummate transactions.

An example embodiment of social networking based transactions may include data providers 200 posting data and information for selling products and services—the data providers 200 may invite other data providers 200 and data consumers 300 to participate in assisting to sell the selling data provider's products and services. This may include compensation based or compensation free assistance. In compensation based assistance, the referral party may receive monetary or other forms of compensation for helping consummate the selling data provider's products and services. A specific example of such social networking based selling transaction may include a subscriber of the Internet eco system 1 may post information regarding the sale of an automobile—the post may include such information as but not limited to the car manufacturers, new or used car, model year, condition, features and price; the subscriber may invite other subscribers of the Internet eco system 1 to assist him or her in consummating such a transaction. The Internet eco system 1 provides means for the invited party or parties to obtain monetary or other forms of compensation.

Another example embodiment of social networking based transactions may include data providers 200 posting transactional information based data seeking to purchase products and services—the data providers 200 may invite other data providers 200 and data consumers 300 to participate in assisting to purchase the products and services. This may include compensation based or compensation free assistance. In compensation based assistance, the referral party may receive monetary or other forms of compensation for helping the purchasing data provider to purchase products and services. A specific example of such social networking based purchase transaction may include a subscriber of the Internet eco system 1 may post information regarding the purchase of an automobile—the post may include such information as but not limited to the car manufacturers, new or used car, model year, condition, features and price; the subscriber may invite other subscribers of the Internet eco system 1 to assist him or her in consummating such a transaction. The Internet eco system 1 provides means for the invited party or parties to obtain monetary or other forms of compensation.

In a social networking oriented transactions, data providers 200 can also be data consumers 300 and data consumers 300 can also be data providers 200.

The Internet eco system 1 of the present invention provides mechanisms for the settlement of monetary and non monetary compensation; examples of social networking and non social networking based transaction settlement may include but not limited to pre approval, post approval, special financing etc.

The Internet eco system 1 by means of the embedded logic of the informational eco system 100 also provides means for data providers 200 of the consumer types and also of the types of for profit corporations, not for profit corporations and government entities to post informational data and transactional data to engage and conduct in barter based transactions. An example of an informational data based barter transaction can be of the type of the subscribers of the Internet eco system 1 permit each other to view their profiles, resumes, truth meter score and identification credentials, pictures, videos, health information, financial information family information and other informational data views. The Internet eco system 1 provides mechanisms for system users to barter specific informational views, for example a profile for profile view, a video for a video view etc. The Internet eco system 1 also provides mechanisms for system users for bartering mix and match informational views.

The Internet eco system 1 of the present invention also provides mechanism for system users of the type 200 and or of the type 300 to engage in transactional data based product and or services barter transactions. An example type of transactional data based barter transaction can be an Organization A wanting to barter a fleet of x executive driven corporate cars with y new cars posts such barter transactional data on the informational eco system 100. Another Organization B of the example type a car dealer can then search the informational eco system 100 to search and identify barter opportunities. Organization A and Organization B of this particular example type can then choose to engage and consummate the x used cars for y new cars transactional data based barter transactions. Another example of a barter based services transaction can be an Organization A posts services based transactional data requirements on to the informational eco system 100 stating any Organization B with skills to implement a Human Resources software application can also use such an application for Organization's B own internal use upon the successful implementation of the software application. An Organization B who has the skilled resources to implement a Human Resources software application but may not have the capital to purchase the software and hardware and is in need of a Human Resources software application for their internal use can then choose to engage in such a barter transaction.

An additional example of barter based product transactions can be between an individual A who wants to barter his or her car for a motorcycle and a sofa. Individual B who has a motorcycle and a sofa who may be in need of a car can then choose to engage in such a barter transaction.

The Internet eco system 1 provides mechanism for system users of all types to negotiate with each other when engaged in compensation and or barter based transactions. Such transactions can be of type informational transactions and can also be of the type of transactional transactions. System users of the Internet eco system can also choose to engage in a hybrid form of barter and compensation based transactions. For example, an individual A may want to barter his or her car for a motorcycle and a sofa. Individual B who may have a motorcycle but may not have a sofa can then negotiate with individual B to barter his or her motorcycle and a certain amount of money for Individual A's car. Another example of a hybrid transaction may be an Organization A may want to barter their fleet of x executive driven corporate cars with a y quantity of office furniture and a certain amount of cash.

The Internet eco system 1 of the present invention can be governed by one or more policies. Policy examples can include but not limited to:
1. The Internet eco system may impose a fee for data postings and data search and retrieval.
2. The Internet eco system may allow data providers to put access restrictions on data.
3. The Internet eco system may allow system users to post data based on one or more data posting logic.
4. The Internet eco system may allow system users to search and retrieve data based on more or more data search and retrieve logic; etc.

While particular embodiments are described and illustrated, the particular embodiments described and illustrated are only representative of the subject matter contemplated. The scope of the present invention encompasses embodiments that are or could become apparent to those skilled in the art, and the scope of the present invention is to be limited only by the appended claims. In the claims, reference to an element in the singular is not intended to mean one and only one, but rather one or more unless explicitly stated. The present invention encompasses all structural and functional equivalents to the elements of the embodiments described and illustrated that are known or later come to be known to those of ordinary skill in the art. Moreover, it is not necessary for a device, method, or logic to address each and every problem sought to be solved by the present invention to be encompassed by the present claims. No element, component, or method step in the described and illustrated embodiments is intended to be dedicated to the public regardless of whether the element, component, or method step is explicitly recited in the claims. No claim element herein is to be construed under the provisions of 35 U.S.C. sections 112, sixth paragraph, unless the element is expressly recited using the phrase “means for.”

What is claimed is:

1. An Internet eco system comprising of data providers, data consumers, an Informational eco system and the public Internet for data posting and data search and retrieval for the purpose of transacting personal, confidential and business data for compensation.

2. The system of claim 1 wherein the personal, confidential and business data can be informational in nature leading to informational transactions or can be products and services based data leading to transactional transactions.

3. The system of claim 2 wherein the compensation for informational transactions and transactional transactions can be based on system credits, monetary compensation, barter compensation or any combination thereof.

4. The system of claim 1;
wherein data providers and data consumers comprising of individuals, organizations and government entities post personal, confidential and business data in the Information eco system in textual format, pictorial format, video format, multimedia format or any combination thereof.
wherein data providers and data consumers comprising of individuals, organizations and government entities search and retrieve personal, confidential and business data; and
wherein data providers and data consumers conduct informational transactions and transactional transactions.

5. The system of claim 1;
wherein the Informational eco system comprising of an application engine; a search engine and a data store communicably coupled via a web services messaging module;
wherein the Information eco system logic components can be housed at single site or at multiple sites whereby the multiple sites can be based in the same geography or can be disbursed across multiple geographies;
wherein the system users post personal, confidential and business data in the Informational eco system using free form posting, system forms based posting, keywords based posting, context based posting, constraints based posting, policies based posting, facts based posting, rules based posting, workflow based posting, mathematical logic based posting, meta posting logic based posting or any combination thereof; and
wherein system users search and retrieve personal, confidential and business data from the Informational eco system by means of keywords based search, context based search, constraints based search, policies based search, facts based search, rules based search, workflow based search, and mathematical logic based search or any combination thereof;

6. The system of claim 5, wherein data providers can also be data consumers and data consumers can also be data providers.

7. The system of claim 2, wherein the compensation for conducting transactions can be based on one or more types of compensation schemes comprising of a one-time compensation, a fixed or a variable pay per access compensation, a fixed or variable periodic compensation or a flat rate compensation.

8. The system of claim 1, wherein data postings can be posted in one or more meta categories constituting of personal meta categories, business meta categories and government meta categories; the meta categories comprising of one or more sub categories.

9. The system of claim 2, wherein compensation can be earned as fixed compensation, auction type compensation or reverse auction type compensation.

10. The system of claim 1, wherein the Internet eco system is governed by policies.

11. The system of claim 10,
wherein data can be classified as toll data or toll free data;
wherein data providers can put access restrictions on toll and toll free data access;
wherein toll data and toll free data can be for exclusive use, one time use, time based use, recurring use or a combination thereof; and
wherein restricted users can bid for restricted data for exclusive use, one time use, time based use, recurring use or a combination thereof.

12. The system of claim 1, wherein data providers may earn compensation for posting personal, confidential and business data and data consumers may pay a micro fee, a periodic fee, a flat rate fee or a combination thereof for searching and retrieving data providers' personal, confidential and business data.

13. The system of claim 1, wherein systems users can earn compensation for watching advertisements and can also earn compensation for interacting with advertisements.

14. The system of claim 1, wherein systems users can receive earned compensation instantly or periodically.

15. The system of claim 1,
wherein search queries executed against the informational eco system can also be executed against the Internet and search queries executed against the Internet can also be executed against the informational eco system.
wherein informational eco system search queries are executed, against the one or more informational eco system indices;
wherein data retrieved in response to Informational eco system search queries may also be subject to one or more qualifiers including but not limited to user profile, system qualifiers and informational eco system intelligence for precision data filtering.
wherein Internet search queries may be executed, against the one or more informational eco system indices;
wherein data retrieved in response to search Internet queries may also be subject to one or more qualifiers including but not limited to user profile, system qualifiers and informational eco system intelligence for precision data filtering.

16. A method for conducting informational transactions and transactional transactions utilizing one or more services of the application engine comprising authentication, authorization, accounting services, data indexing services, data classification services, heuristics and algorithm services, activity metering services, fraud detection and prevention services, user identification, verification and dispute resolution services, feedback mechanism services, payments and systems credit settlement services, virtual agents services, third party interfacing services and interfaces to search logic services.

17. The method of claim 18, wherein data providers and data consumers can create virtual agents to represent and transact on their behalf.

18. The method of claim 16,
wherein identification and verification of system users can be performed by digital means by physical means or a combination thereof; and
wherein truth score may be computed in one or more combinations of identification credentials, transactions history, fraud history, user feedback, system intelligence and system policies.

19. A method wherein data providers and data consumers invite other system users to assist in informational transactions and transactional transactions in a social networking paradigm.

20. The method of claim 19 wherein social networking participants may earn compensation for helping consummate informational transactions and transactional transactions.
